(19) United States
(12) Patent Application Publication
(10) Pub. No.: US 2012/0323897 A1
(43) Pub. Date: Dec. 20, 2012

(54) QUERY-DEPENDENT AUDIO/VIDEO CLIP SEARCH RESULT PREVIEWS

(75) Inventors: ANTOINE EL DAHER, KENMORE, WA (US); FARAH M. ALI, KIRKLAND, WA (US)

(73) Assignee: MICROSOFT CORPORATION, REDMOND, WA (US)

(21) Appl. No.: 13/159,851

(22) Filed: Jun. 14, 2011

(51) Int. Cl. G06F 17/30

(52) U.S. Cl. 707/723; 707/722; 707/E17.028; 707/E17.101; 707/E17.082

(57) ABSTRACT

Systems, methods, and computer media for providing query-dependent audio and video clip previews are provided. Using the systems and methods described herein, an identification of an audio or video clip relevant to a user search query is received. The user search query has one or more keywords. Occurrences of the keywords and the locations of the occurrences are identified in a transcription of the identified audio or video clip. Clip segments are extracted from the audio or video clip. Each extracted clip segment includes an identified keyword occurrence. A query-dependent clip preview is created that includes at least one extracted clip segment. The query-dependent clip preview can be provided in search results for the user search query to provide an informative preview that is specific to the query to which the clip is relevant.

### BACKGROUND

Internet searching has become increasingly common in recent years. Search engines conventionally receive a user keyword or other search query and return a search results page including links to identified search results. Initially, search result pages primarily included links to relevant text found on web pages. As audio and video clips have become more commonly included in web pages, search engines have correspondingly begun identifying relevant audio and video clips and including the identified clips in search result pages.

Audio and video clip search results may also include a clip preview that enables a user to quickly assess the relevance of the clip to the user's search query. Conventionally, however, a single preview is generated for each audio or video clip regardless of the user's search query. Two different queries seeking different information that both identify a particular clip as relevant will thus both include the same clip preview. Depending on the search query, this “one-size-fits-all” approach to audio and video clip previews may not provide a user with an informative clip preview.

### SUMMARY

Embodiments of the present invention relate to systems, methods, and computer media for providing query-dependent audio and video clip previews. Using the systems and methods described herein, an identification of an audio or video clip relevant to a user search query is received. The user search query has one or more keywords. Occurrences of the keywords and the locations of the occurrences are identified in a transcription of the identified audio or video clip. One or more clip segments are extracted from the audio or video clip. Each extracted clip segment includes an identified keyword occurrence. A query-dependent clip preview is created that includes at least one extracted clip segment including a keyword occurrence.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram of a query-dependent audio or video clip preview generation system in accordance with embodiments of the present invention;

FIG. 3 is an exemplary search results page including query-dependent audio or video clip previews for clips determined to be relevant to a user search query in accordance with embodiments of the present invention; and

FIG. 4 is a flow chart of an exemplary method for providing a query-dependent audio or video clip preview in accordance with an embodiment of the present invention.

### DETAILED DESCRIPTION

Embodiments of the present invention are described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” or “module” etc. might be used herein to connote different components of methods or systems employed, the terms should not be interpreted as implying any particular order among or between various steps herein disclosed unless and except when the order of individual steps is explicitly described.

Embodiments of the present invention relate to systems, methods, and computer media for providing query-dependent audio and video clip previews. As discussed above, conventionally, only one clip preview for an audio or video clip is generated for use in search results, regardless of the keywords used to identify the clip as relevant. Thus, in a conventional system, if a first user searches for a first keyword and a video clip is returned in a first search results page, and a second user searches for a second keyword and the same video clip is returned in a second search results page, the accompanying video clip preview included in both search results pages is the same preview.

Clip previews generally include multiple portions of a clip stitched together. Even though an audio or video clip as a whole may be relevant to a user search query, the clip preview itself may not contain any portions of the clip that are relevant. Thus, depending on what portions of a clip are included in the corresponding preview, a clip preview may be informative for some search queries and not informative for others.

In accordance with embodiments of the present invention, a query-dependent clip preview can be provided along with search results for a user search query to give a user a clip preview that is specific to the user's query.

In one embodiment of the present invention, an identification of an audio or video clip relevant to a user search query is received. The user search query has one or more keywords. One or more keyword occurrences of at least one of the one or more keywords are identified in a transcription of the identified audio or video clip. The locations of the one or more keyword occurrences in the transcription are also identified. One or more clip segments are extracted from the audio or video clip. Each extracted clip segment includes an identified keyword occurrence. A query-dependent clip preview is created that includes at least one of the one or more extracted clip segments that each include an identified keyword occurrence.

In another embodiment, a clip identification component receives an identification of an audio or video clip relevant to a user search query. The user search query having one or more keywords. A transcription analysis component identifies (1) one or more keyword occurrences of at least one of the one or more keywords in a transcription of the identified audio or video clip and (2) the locations of the one or more keyword occurrences in the transcription. A clip segment extraction component extracts one or more clip segments from the audio or video clip. Each extracted clip segment includes an identified keyword occurrence. A preview generation component creates a query-dependent clip preview that includes at least one of the one or more extracted clip segments that each include an identified keyword occurrence.

In still another embodiment, an identification of an audio or video clip relevant to a user search query is received. The user search query has one or more keywords. One or more keyword occurrences of at least one of the one or more keywords are identified in a transcription of the identified audio or video clip. The locations of the one or more keyword occurrences in the transcription are also identified. A plurality of clip segments are extracted from the audio or video clip. Each extracted clip segment including an identified keyword occurrence. Using a processor of a computing device, a query-dependent clip preview is created that includes at least two of the plurality of extracted clip segments that each include an identified keyword occurrence. The location of one of the one or more identified keyword occurrences is selected as a linked clip start point. A user selection of a search result page link to the relevant audio or video clip causes the relevant audio or video clip to begin play at the linked clip start point. A search results page is provided for the user search query that includes both a link to the relevant audio or video clip and the query-dependent clip preview.

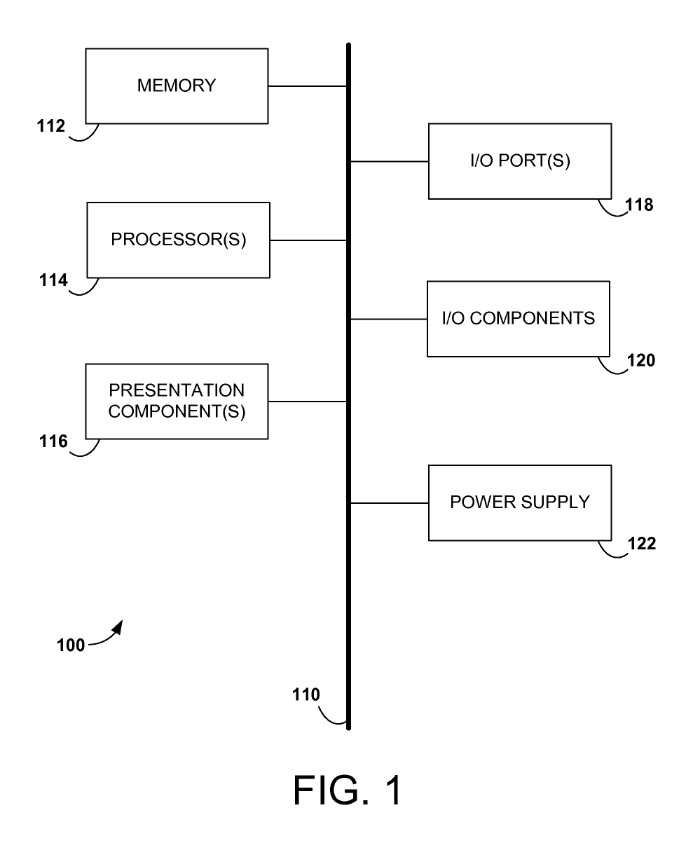

Having briefly described an overview of some embodiments of the present invention, an exemplary operating environment in which embodiments of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of embodiments of the present invention. Neither should the computing device 100 be interpreted as having any dependency or requirement relating to any one or combination of components illustrated.

Embodiments of the present invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. Embodiments of the present invention may be practiced in a variety of system configurations, including hand-held devices, consumer electronics, general-purpose computers, more specialty computing devices, etc. Embodiments of the present invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100.

Communication media typically embodies computer-readable instructions, data structures, program modules, or other data in a modulated data signal such as a carrier wave. The term “modulated data signal” refers to a propagated signal that has one or more of its characteristics set or changed to encode information in the signal. By way of example, and not limitation, communication media includes wired media, such as a wired network or direct-wired connection, and wireless media such as acoustic, RF, infrared, radio, microwave, spread-spectrum, and other wireless media. Combinations of the above are included within the scope of computer-readable media.

Memory 112 includes computer storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

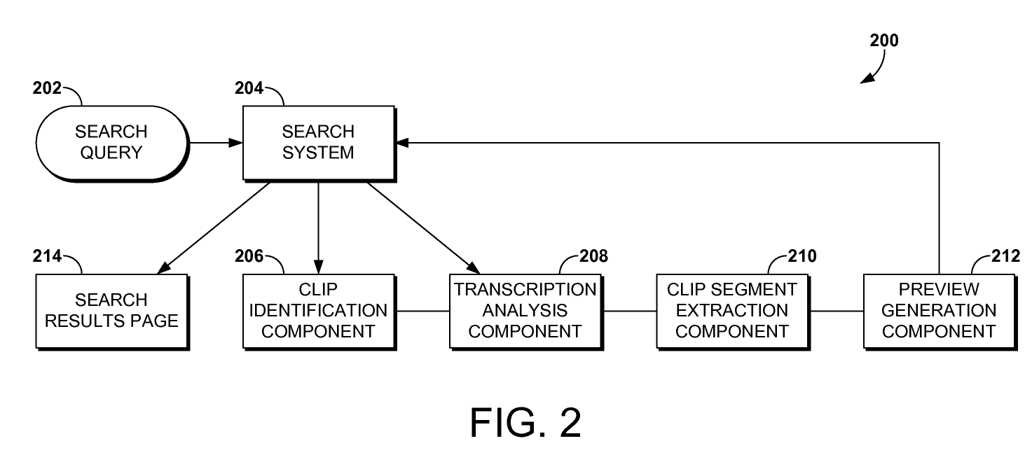

As discussed previously, embodiments of the present invention relate to systems, methods, and computer media for providing query-dependent audio or video clip previews. Embodiments of the present invention will be discussed with reference to FIGS. 2-4.

FIG. 2 is a block diagram illustrating an exemplary query-dependent audio or video clip preview generation system 200. User search query 202 is received by search system 204. User search query 202 may be a keyword search including one or more keywords, an image search, or another type of search. Search systems such as search system 204 are known in the art and may contain a number of servers or other devices that implement a variety of algorithms to: crawl the Internet to identify and index web pages and resources; receive user search queries; identify web pages and resources relevant to user queries; and generate search results web pages including relevant web pages and/or resources.

In response to receiving user search query 202, search system 204 identifies relevant web pages and/or resources, including relevant audio and/or video clips. Clip identification component 206 receives an identification of an audio or video clip relevant to user search query 202. Clip identification component 206 communicates the identification to a transcription analysis component 208. Transcription analysis component 208 analyzes a transcript of the identified audio or video clip relevant to user search query 202 by searching for keyword occurrences of the keywords comprising search query 202. Transcription analysis component 208 identifies both keyword occurrences of the keywords comprising search query 202 as well as the locations of the keyword occurrences in the transcription. The words “transcript” and “transcription” are used interchangeably in this document.

In some embodiments, transcription of an audio or video clip is performed by search system 204. In such embodiments, audio and video clips are identified by search system 204 during the crawling process. Through various processes known in the art, for example, by analyzing the URL pattern, domain, title of the clip or web page, or other features, it can be determined if an audio or video clip is speech-based. Speech recognition technology is applied to speech-based clips to generate a transcript. Each word recognized above a predetermined confidence threshold is tagged with a timestamp corresponding to the location (time) the word was said in the clip. A reverse index is then generated such that a first column includes recognized words in the clip, and a second column includes a list of timestamps for each word where the word appears in the clip. The reverse index is stored with the audio or video clip or data about the audio or video clip in the search engine's index. In other embodiments, transcription analysis component 208 may perform transcription after identification of a relevant clip is received. In still other embodiments, transcription of identified clips may be performed dynamically by search system 204.

Identified keyword occurrences and the locations at which the occurrences are found in the clip are provided to a clip segment extraction component 210. Clip segment extraction component 210 extracts one or more clip segments from the audio or video clip. Each extracted clip segment includes an identified keyword occurrence. Clip segments can be determined in a variety of ways. In one embodiment, clip segments are a pre-determined length—for example, 10 seconds. In other embodiments, clip segments are long enough to include desirable information. For example, if 12 occurrences of a keyword are present in a 6-second span and no or few occurrences are present in the 10 seconds on either side of the 6-second span, a clip segment may be identified and extracted that includes the entire 6-second span and as little additional time on either side of the span as is possible to make a clean segment. In one embodiment, segments begin and end during a brief silence or pause in speech so as to provide a natural transition.

Each clip segment extracted from the relevant audio or video clip by clip segment extraction component 210 includes at least one keyword occurrence of at least one keyword. Clip segment extraction component 210 provides one or more extracted clip segments to preview generation component 212. Preview generation component 212 creates a query-dependent clip preview that includes at least one of the one or more extracted clip segments that each include an identified keyword occurrence. Thus, preview generation component 212 creates a clip preview customized for received user search query 202 by creating the preview from one or more clip segments that each mention at least one keyword included in query 202. The query-dependent clip preview created by preview generation component 212 is much more likely to provide useful information to a user than a standard, query-independent clip preview that may not be relevant to any of the user's search terms.

For example, a news clip may contain information related to multiple stories. There may be a headline story and a few minor stories. If the news clip is identified as relevant to a user's search for a minor story, a standard clip preview that is created may focus on the headline story and may not include information about the minor story. Such a preview is not helpful to the user. By implementing the components of system 200, a query-dependent clip preview is generated by combining clip segments that are relevant to the user's particular query—in this case, the query-dependent clip preview would include clip segments that discuss the minor news story.

In some instances, a query keyword may only appear once in a clip. In such cases, the clip preview may be selected as a 30-second or other pre-determined time window centered around or otherwise including the one occurrence. In other instances, one or more query keywords may appear a large number of times. In such cases, occurrences may be ranked, and the clip segments extracted by clip segment extraction component 210 include occurrences that are highly ranked. The query-dependent clip preview created by preview generation component 212 may include a predetermined number of the extracted clip segments that include highly ranked keyword occurrences. The ranking could be based on, for example, the number of other occurrences near the occurrence or the proximity of an occurrence of each query term.

In some embodiments, time segments prior to extraction or extracted clip segments may be ranked in addition to or instead of occurrences. For example, based on clustering of keyword occurrences or the number of keyword occurrences of various keywords in a particular time period, a time segment may be identified. Additional time segments may then be identified. The time segments may then be ranked, for example by the number of keyword occurrences in the time segment or by the ranking of the keyword occurrences in the time segment, and the highest-ranked segments may be extracted as clip segments.

Occurrences may also be ranked more highly if they are part of a key phrase. A key phrase is a group of words that often appear together. Key phrases may be identified using a pre-determined list or by analyzing transcribed audio and video clips or web pages and determining groups of words that frequently appear together. Thus, if a user has searched for two words that comprise a key phrase, occurrences of both words together may be more relevant and informative that occurrences of either word individually. In one embodiment, user search query 202 includes a plurality of keywords, and when the plurality of keywords includes a key phrase, clip segment extraction component 210 ranks occurrences of the key phrase in the transcription higher than individual occurrences of the plurality of keywords.

In some embodiments, clip segment extraction component 210 extracts a plurality of clip segments from an audio or video clip, and the query-dependent clip preview created by preview generation component 212 includes at least two of the extracted clip segments. In other embodiments, the keyword occurrences identified by transcription analysis component 208 are ranked, and the query-dependent clip preview created by preview generation component 212 includes three extracted clip segments that include highly ranked keyword occurrences, with each extracted clip segment included in the query-dependent clip preview being approximately 10 seconds long.

In still other embodiments, the length of the query-dependent clip preview is proportional to the length of the audio or video clip. For example, if a video clip is an hour long, preview generation component 212 may create a longer preview than if the clip were five minutes long. The proportionality can be according to a predetermined ratio or can be a rough proportionality involving general classifications of “long,” “standard,” and “short,” for example.

Search results page 214 may be generated by search system 204 and includes a link to the relevant audio or video clip along with the query-dependent clip summary.

The functionality of the various components of system 200 may be embodied on one or many physical devices, and various embodiments may not include all components shown in FIG. 2.

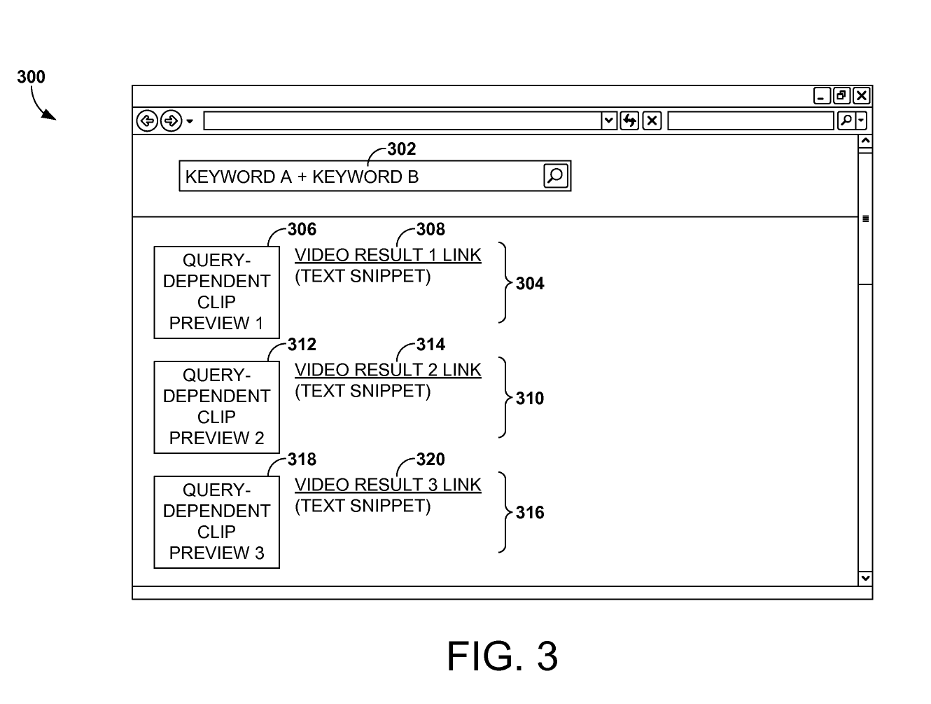

FIG. 3 illustrates an exemplary search results page 300 that includes query-dependent clip previews along with search results, as discussed above with reference to search results page 214 in FIG. 2. Other search results pages and formats for search results are envisioned. In FIG. 3, a user has submitted a search query 302 of “keyword A+keyword B.” Search results page 300 includes video search results 304, 310, and 316. Search result 304 includes a query-dependent clip preview 306, a link 308 to the full video result, and a text snippet describing the video result. Similarly, search results 310 and 316 include query-dependent clip previews 312 and 318, links 314 and 320 to the full videos, and text snippets describing the video results. In one embodiment, a user hover over or selection of one of previews 306, 312, or 318 causes the preview to begin play. In another embodiment, a user hover over one of previews 306, 312, or 318 causes the preview to begin play, but a user selection of a preview navigates the user to the web page where the full video is hosted. In still another embodiment, selection of links 308, 314, or 320 navigates the user to the web page where the full video is hosted.

In some embodiments, when a user is navigated to the web page where the full video is hosted, the video begins play or is positioned to begin play at the location of an identified keyword occurrence. In this way, a user is directed straight to a relevant portion of the clip. In such embodiments, the occurrence is identified as a linked clip start point. In other embodiments, when the full clip is viewed, the locations of additional keyword occurrences in the audio or video clip are displayed with the audio or video clip. For example, markers may be included in a video or audio player indicating additional keyword occurrences. A user selection of one of the displayed additional keyword occurrence locations causes the audio or video clip to play the portion of the clip corresponding to the location of the keyword occurrence—that is, the clip will skip forward or backward to the location of the selected additional occurrence.

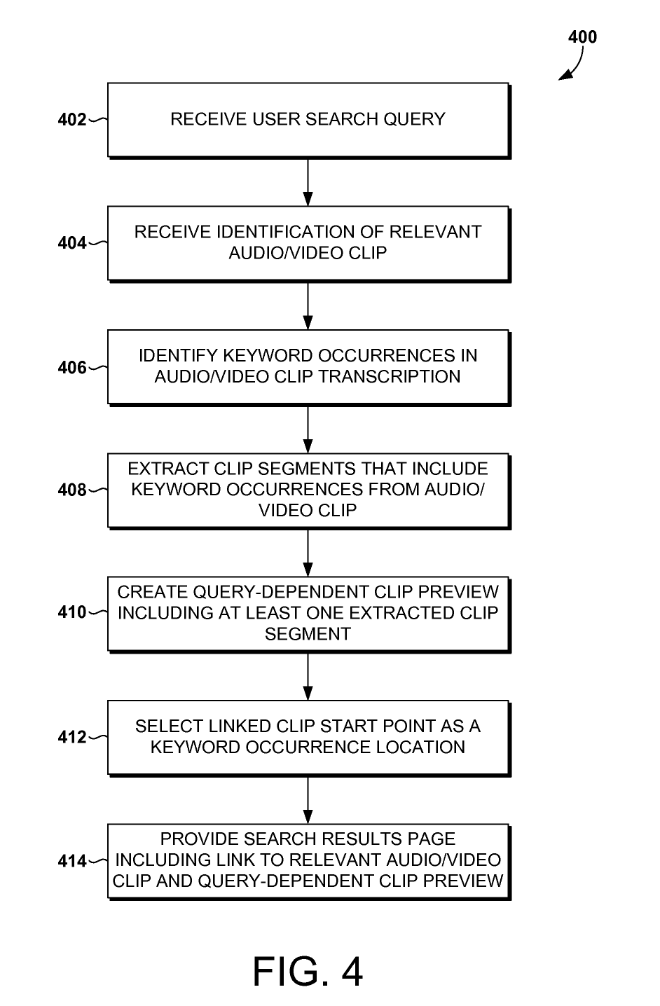

FIG. 4 illustrates a method 400 of providing query-dependent audio or video clip previews. A user search query is received in step 402. An identification of an audio or video clip relevant to a user search query is received in step 404. The user search query has one or more keywords. In step 406, one or more keyword occurrences of at least one of the one or more keywords are identified in a transcription of the identified audio or video clip, and the locations of the one or more keyword occurrences in the transcription are also identified. One or more clip segments are extracted from the audio or video clip in step 408. In some embodiments, a plurality of clip segments are extracted in step 408. Each extracted clip segment includes an identified keyword occurrence. In step 410, a query-dependent clip preview is created that includes at least one of the one or more extracted clip segments that each include an identified keyword occurrence. In some embodiments, the query-dependent clip preview includes at least two of the extracted clip segments.

In some embodiments, the location of one of the one or more keyword occurrences is selected as a linked clip start point in step 412. A user selection of the link to the relevant audio or video clip causes the relevant audio or video clip to begin play at the linked clip start point. In some embodiments, step 414 is performed. In step 414, a search results page for the user search query is provided that includes both a link to the relevant audio or video clip and the query-dependent clip preview.

In other embodiments, the keyword occurrences identified in step 406 are ranked, and the query-dependent clip preview created in step 410 includes a predetermined number of the extracted clip segments that include at least one highly ranked keyword occurrence. In one particular embodiment, the predetermined number of extracted clip segments is three, each extracted clip segment included in the created query-dependent clip preview is approximately 10 seconds long. In another embodiment, the query-dependent clip preview is approximately 30 seconds long. In still another embodiment, upon determining that the plurality of keywords includes a key phrase, occurrences of the key phrase in the transcription are ranked higher than individual occurrences of the plurality of keywords.

In one embodiment, the plurality of extracted clip segments are ranked, rather than or in addition to ranking the occurrences. In such an embodiment, the query-dependent clip preview includes a predetermined number of the extracted clip segments ranked the highest.

Various embodiments may not include all steps shown in FIG. 4, and other embodiments may include additional steps not shown in FIG. 4. Method 400 may be implemented on a computing device having a processor. Each of steps 402, 404, 406, 408, 410, 412, and 414 may be performed using the processor.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated by and is within the scope of the claims.

Having thus described the invention, what is claimed is:

1. Computer-readable media having embodied thereon computer-executable instructions that, when executed by a computing device, perform a method for providing query-dependent audio and video clip previews, the method comprising:
receiving an identification of an audio or video clip relevant to a user search query, the user search query having one or more keywords;
identifying (1) one or more keyword occurrences of at least one of the one or more keywords in a transcription of the identified audio or video clip and (2) the locations of the one or more keyword occurrences in the transcription;
extracting one or more clip segments from the audio or video clip, each extracted clip segment including an identified keyword occurrence; and
creating a query-dependent clip preview that includes at least one of the one or more extracted clip segments that each include an identified keyword occurrence.

2. The computer-readable media of claim 1, further comprising providing a search results page for the user search query that includes both a link to the relevant audio or video clip and the query-dependent clip preview.

3. The computer-readable media of claim 2, further comprising selecting the location of one of the one or more keyword occurrences as a linked clip start point, wherein a user selection of the link to the relevant audio or video clip causes the relevant audio or video clip to begin play at the linked clip start point.

4. The computer-readable media of claim 3, wherein the locations of additional keyword occurrences in the audio or video clip are displayed with the audio or video clip, and wherein a user selection of one of the displayed additional keyword occurrence locations causes the audio or video clip to play the portion of the clip corresponding to the location of the keyword occurrence.

5. The computer-readable media of claim 1, wherein a plurality of clip segments are extracted from the audio or video clip.

6. The computer-readable media of claim 5, wherein the query-dependent clip preview includes at least two of the extracted clip segments.

7. The computer-readable media of claim 1, wherein the identified keyword occurrences are ranked, and wherein the query-dependent clip preview includes a predetermined number of the extracted clip segments that include at least one highly ranked keyword occurrence.

8. The computer-readable media of claim 7, wherein the predetermined number of extracted clip segments is three, and wherein each extracted clip segment included in the query-dependent clip preview is approximately 10 seconds long.

9. The computer-readable media of claim 7, wherein the user search query includes a plurality of keywords, and further comprising upon determining that the plurality of keywords includes a key phrase, ranking occurrences of the key phrase in the transcription higher than individual occurrences of the plurality of keywords.

10. The computer-readable media of claim 1, wherein the query-dependent clip preview is approximately 30 seconds long.

11. The computer-readable media of claim 1, wherein the length of the query-dependent clip preview is proportional to the length of the audio or video clip.

12. One or more computer-readable media having a system embodied thereon including computer-executable instructions that, when executed, perform a method for providing query-dependent audio and video clip previews, the system comprising:
a clip identification component that receives an identification of an audio or video clip relevant to a user search query, the user search query having one or more keywords;
a transcription analysis component that identifies (1) one or more keyword occurrences of at least one of the one or more keywords in a transcription of the identified audio or video clip and (2) the locations of the one or more keyword occurrences in the transcription;
a clip segment extraction component that extracts one or more clip segments from the audio or video clip, each extracted clip segment including an identified keyword occurrence; and
a preview generation component that creates a query-dependent clip preview that includes at least one of the one or more extracted clip segments that each include an identified keyword occurrence.

13. The computer-readable media of claim 12, wherein the clip segment extraction component extracts a plurality of clip segments from the audio or video clip, and wherein the query-dependent clip preview includes at least two of the extracted clip segments.

14. The computer-readable media of claim 12, wherein the identified keyword occurrences are ranked, wherein the clip segments extracted by the clip segment extraction component include keyword occurrences that are highly ranked, and wherein the query-dependent clip preview created by the preview generation component includes a predetermined number of the extracted clip segments that include at least one highly ranked keyword occurrence.

15. The computer-readable media of claim 14, wherein the predetermined number of extracted clip segments is three, and wherein each extracted clip segment included in the query-dependent clip preview is approximately 10 seconds long.

16. The computer-readable media of claim 14, wherein the user search query includes a plurality of keywords, and further comprising upon determining that the plurality of keywords includes a key phrase, the clip segment extraction component ranks occurrences of the key phrase in the transcription higher than individual occurrences of the plurality of keywords.

17. The computer-readable media of claim 12, wherein the length of the query-dependent clip preview is proportional to the length of the audio or video clip.

18. A computer-implemented method for providing query-dependent audio and video clip previews, the method comprising:
receiving an identification of an audio or video clip relevant to a user search query, the user search query having one or more keywords;
identifying (1) one or more keyword occurrences of at least one of the one or more keywords in a transcription of the identified audio or video clip and (2) the locations of the one or more keyword occurrences in the transcription;
extracting a plurality of clip segments from the audio or video clip, each extracted clip segment including an identified keyword occurrence;
using a processor of a computing device to create a query-dependent clip preview that includes at least two of the plurality of extracted clip segments that each include an identified keyword occurrence;
selecting the location of one of the one or more identified keyword occurrences as a linked clip start point, wherein a user selection of a search result page link to the relevant audio or video clip causes the relevant audio or video clip to begin play at the linked clip start point; and
providing a search results page for the user search query that includes both a link to the relevant audio or video clip and the query-dependent clip preview.

19. The method of claim 18, wherein the plurality of extracted clip segments are ranked, and wherein the query-dependent clip preview includes a predetermined number of the extracted clip segments ranked the highest.

20. The method of claim 18, wherein the length of the query-dependent clip preview is proportional to the length of the audio or video clip.
